(19) United States
(12) Patent Application Publication
(10) Pub. No.: US 2018/0283356 A1
(43) Pub. Date: Oct. 4, 2018

(54) APPARATUS FOR PRESENTING MEASUREMENT DATA OF A WIND ENERGY INSTALLATION AND/OR THE COMPONENTS THEREOF

(71) Applicant: Wobben Properties GmbH, Aurich (DE)

(72) Inventor: Simon DEMUTH, Hage (DE)

(21) Appl. No.: 15/778,487

(22) PCT Filed: Nov. 8, 2016
(86) PCT No.: PCT/EP2016/076907

§ 371 Date: May 23, 2018

(30) Foreign Application Priority Data
Nov. 24, 2015 (DE) 10 2015 120 305.7

(51) Int. Cl. F03D 7/04; F03D 17/00

(52) U.S. Cl. CPC F03D 7/047; F05B 2270/804; F03D 17/00

(57) ABSTRACT

A method and an apparatus for presenting measurement data from a plurality of sensors of a physical wind power installation or its components on a display is provided. At least one view of an image of a wind power installation and/or of at least one component of the wind power installation and of a plurality of interaction elements is presented together with the view. At least one sensor of the wind power installation or of the component respectively assigned to each interaction element a controller. The measured values made by the sensor(s) can be retrieved via the assigned interaction element. In addition, each interaction element is respectively arranged in substantially the same position in the view as a position at which the at least one sensor assigned to the respective interaction element is arranged in the physical wind power installation or its component.

### BACKGROUND

### Technical Field

The invention relates to a method for presenting measurement data from a plurality of sensors of a wind power installation and/or its components using a display device. The invention also relates to an apparatus for presenting measurement data from a plurality of sensors of a wind power installation and/or its components and to a system having the apparatus and a plurality of sensors of a wind power installation for carrying out the method.

### Description of the Related Art

Wind power installations have a multiplicity of sensors which are used to assist with the control or regulation of the wind power installation during operation. These sensors are also used to make it possible to present the current operating state of a wind power installation.

The sensors are sensors which measure, for example, currents, voltages, temperatures and environmental influences on the wind power installation, such as the wind speed and wind direction.

If the state of a wind power installation is now intended to be queried by a service employee, the measured values can be presented in a list. In this list, sensors with their designation are listed in rows inside a first column and the corresponding measured values are listed in a column beside this, for example. Several hundred sensors are installed in modern wind power installations, with the result that the corresponding list has several hundred rows for the service employee.

If the service employee now wishes to check a particular measured value from a particular sensor, he must first of all find this measured value in the list, which is cumbersome. Furthermore, measured values which differ from the norm or from standard values can be found by the service employee only if the latter compares the measured values with a standard value range, the standard value range for each sensor being included in a further list, for example. In any event, it is cumbersome to search for differing measured values in a list containing several hundred rows. There is, therefore, a risk of differing measured values not being found at all or being overlooked in the list.

In the priority application for the present application, the German Patent and Trademark Office researched the following prior art: DE 10 2007 011 835 A1 and US 2014/0163904 A1.

### BRIEF SUMMARY

Disclosed herein is visualization of the measurement data from sensors of wind power installations and/or their components for a service employee in such a manner that the latter obtains a quick overview of the current operating state of the wind power installation and, in particular, can discern measurement data differing from the normal range as easily as possible.

A method and an apparatus for presenting measurement data from a plurality of sensors of a wind power installation and/or its components using a display are provided.

A view of an image of at least one wind power installation and/or of at least one component of a wind power installation is first of all presented using a display by means of a controller. A plurality of interaction elements are then presented together with the view of the image of the wind power installation and/or components using the display by means of the controller.

At least one sensor of at least one real wind power installation and/or of at least one real component of a wind power installation is respectively assigned to each interaction element using the controller. In addition, each interaction element is respectively presented substantially at that position in the view of the image of the wind power installation and/or component presented using the display which corresponds to the position at which the at least one sensor assigned to the respective interaction element is arranged in the real wind power installation and/or component.

Therefore, a view of an image of at least one wind power installation and/or component of a wind power installation is thus presented using the display. For this purpose, a photo, a sketch or a computer representation of a wind power installation and/or its components, for example, is stored as an image in the controller. The image therefore represents a real wind power installation and/or component of a wind power installation and comprises one or more views which is/are intended to be presented using a display.

A plurality of interaction elements are presented together with the view of the wind power installation and/or the component using the display. An interaction element is a graphical element which can be used to carry out human-computer interaction. One example of an interaction element is, for example, an operating element or control element which is in turn, for example, a symbol which is also called an icon. In the simplest case, the symbol may also be a simple dot consisting of a plurality of pixels of a display or a marking which can be perceived by a user on a display.

At least one sensor is now respectively assigned to each of the presented interaction elements. That is to say, one or more sensors can be assigned to an interaction element. Each of the sensors assigned to one of the interaction elements is in turn arranged in a real wind power installation or a real component of a wind power installation. There is therefore a link between each interaction element, which is presented together with the view of a wind power installation or a component of a wind power installation, and one or more sensors which are part of a real wind power installation or a real component of a wind power installation.

In this case, a plurality of sensors which are arranged in the same component in the real wind power installation or in the same region of the wind power installation are assigned to the same interaction element, in particular. It is conceivable, for example, for all temperature sensors of a converter of the wind power installation to be assigned to one interaction element.

Each of the interaction elements has a position on the display. These positions have been or are each selected using the controller in such a manner that, in the view of the wind power installation and/or component presented at the same time, they correspond substantially to the position at which the assigned sensor(s) is/are arranged in the real wind power installation and/or component.

For example, an anemometer for measuring the wind speed is arranged on a real wind power installation. The anemometer is positioned, for example, centrally on the nacelle of the wind power installation. In addition to the mechanical parts, the anemometer contains one or more sensors which have electronics and provide, at their output, a signal which varies on the basis of the wind speed. This sensor signal is then passed to a data processing device, for example a computer, of the wind power installation, which determines real wind speed values, for example with the unit of meters per second, from these signals. These values which are obtained from the sensor values are referred to as measured values.

In the example mentioned here with the anemometer, a view, for example from the side, of a wind power installation and an interaction element is presented on a display, the interaction element being assigned to the sensor of the anemometer. The interaction element is then presented centrally above the nacelle in the view. This position in the display therefore corresponds substantially to the position of the sensor in the real wind power installation.

It is therefore possible for a service employee to access the measurement data or measured values from a sensor of a wind power installation and/or its component by only considering the positions in the view at which sensors of a real wind power installation or of the component are arranged according to his knowledge. The measurement data are accessed via the corresponding interaction elements.

According to a first embodiment, one, a plurality of or all of the interaction elements is/are at least partially presented in a color or a shade using the controller, wherein the color or the shade is respectively dependent on the current measured value from the sensor assigned to the interaction element or from the sensors assigned to the respective interaction element.

Each interaction element therefore partially or mostly has a color which changes on the basis of the measured value from the assigned sensor(s) assigned to the interaction element. For example, a blue shade may therefore be assigned to an interaction element assigned to a temperature sensor if the sensor measures very low temperatures. This blue shade can then change, via yellow and/or green tones, to a red shade if the measured temperature of the sensor increases.

If a plurality of sensors are assigned to an interaction element, a representative measured value, for example, for all measured values from the sensors is determined using the controller, for example by mean value formation, other mathematical methods or by determining a positive and/or negative peak value, on the basis of which representative measured value the shade of the interaction element is then adapted.

However, for better clarity, a measured value is always referred to in the present case, but, in the case of a plurality of measured values which are intended to be displayed by an interaction element, a representative measured value is also alternatively or additionally meant at the same time.

The color and/or the shade of the interaction element therefore immediately serve(s) as an indicator of the measured value from the assigned sensor for a service employee.

According to another embodiment, at least one interaction element is at least partially presented in a first shade, for example green, if the sensor assigned to the respective interaction element has current measured values in a normal range predefined for the sensor. Additionally or alternatively, the interaction element is partially presented in a second shade and/or in a flashing manner if the sensor assigned to the interaction element has measured values in a critical range predefined for the sensor. Additionally or alternatively, the interaction element is presented in a third shade, for example yellow, if the sensor assigned to the interaction element has values in a range between the predefined normal range for the sensor and the predefined critical range for the sensor.

According to this exemplary embodiment, a global overview of the measured values from the sensors is possible, since a service employee can immediately infer a range in which the measured values from the assigned sensors lie on the basis of the image of the wind power installation and the color of the interaction elements. If, for example, some of the interaction elements are at least partially presented in a second color, for example red, which is representative of a critical range, the service employee can immediately react to the critical measured values. If, on the other hand, for example, each of the interaction elements is at least partially presented in a first shade, for example green, which indicates measured values in a predefined normal range, a service employee can immediately determine the proper operation of the wind power installation.

According to another embodiment, a region of the view of the wind power installation and/or component is automatically presented in an enlarged form or is optically highlighted by the controller as soon as one or more sensors arranged at the positions in the real wind power installation and/or component which correspond to said region have measured values which are in their critical range or outside their normal range.

A simplified overview and/or simplified access to the interaction elements, which allow access to the measured values from sensors having critical measured values or measured values differing from the normal range, is/are therefore possible. In addition, this enlarged presentation or the optical highlighting of the region additionally points out the critical measured values from the sensors of the interaction elements arranged in this region to a service employee. In particular, the situation in which critical measured values are overlooked by a service employee is also prevented as far as possible.

According to another embodiment, the measured value(s) from the sensor(s) assigned to an interaction element is/are displayed or presented as labeling of the interaction element using the display if the interaction element is selected by selection using an input device, for example a computer mouse, a keyboard or a touch-sensitive display.

For example, if a cursor is moved to the interaction element using the input device, the labeling, that is to say the measured value for example, is displayed until the cursor is moved on. Alternatively or additionally, the labeling is permanently displayed on the display by the controller by initially clicking on the interaction element and is hidden again by the controller by clicking on the interaction element again.

Furthermore, it is therefore possible for the user to display or present one or more measured values from the sensor(s) by simply selecting one or more interaction elements.

It is therefore possible for a service employee wishing to consider detailed measured values, for example, in addition to the measured value ranges presented by a shade of the interaction elements to obtain these measured values by simply selecting the corresponding interaction elements. As a result, a plurality of measured values of interest can be presented on the display, in which case a clear presentation is maintained.

According to another embodiment, the image of the wind power installation and/or component is a three-dimensional image which comprises arbitrary views of the wind power installation and/or component and is stored in the controller. Selecting a view using the input device that the selected view of the image is presented using the display.

According to an alternative of this embodiment, the image which is stored in the controller is two-dimensional and comprises a plurality of, for example four, views which are presented on the display at the same time.

Therefore, the interaction elements can be presented even more accurately—in a manner corresponding to the actual sensor positions in the real wind power installation.

According to another embodiment, a region of the view of the wind power installation or component is presented in an enlarged form on the display device using the controller if this region is selected using the input device. A detailed overview of the measured values from the selected region is therefore possible for the user.

According to another embodiment, a search field which can be used to search for a particular sensor on the basis of a term assigned to it can be displayed on the display by means of the controller, in particular by calling it using the input device. After a search term has been input, a search is then carried out in the controller for sensors which are assigned to interaction elements and can be related to the search term. These sensors are listed in the display by the controller. The input device can then be used to select one of the sensors, whereupon the view on the display is continually changed by the controller in such a manner that “approaching” the interaction element assigned to the selected sensor is simulated. Provision is optionally made for labeling of the interaction element assigned to the sensor to be displayed at the same time.

According to another embodiment of the apparatus, the controller has an interface in order to be connected to a computer or a data processing unit of a wind power installation. The controller also has a memory in order to store the image of at least one wind power installation and/or component. The controller also comprises graphical control in order to control a display. A processor is also provided in order to assign measured values from the sensors of a wind power installation and/or component of a wind power installation, which are received via the interface, to interaction elements and in order to control the display with the aid of the graphical control according to one embodiment, with the result that each interaction element is respectively arranged substantially at that position in the view presented using the display which corresponds substantially to the position at which the sensor assigned to the respective interaction element is arranged in the real wind power installation and/or component.

A system having an apparatus is described herein. A wind power installation having a plurality of sensors, which system is set up, in particular, to carry out an exemplary embodiment of the method is described herein.

### BRIEF DESCRIPTION OF THE SEVERAL VIEWS OF THE DRAWINGS

Further embodiments emerge from exemplary embodiments which are explained in more detail on the basis of the drawings, in which:

FIG. 1 shows a wind power installation,

FIG. 2 shows a display having a view of a wind power installation in an enlarged presentation, and

FIG. 3 shows an exemplary embodiment of the apparatus.

### DETAILED DESCRIPTION

FIG. 1 shows a wind power installation 100 having a tower 102 and a nacelle 104. A rotor 106 having three rotor blades 108 and a spinner 110 is arranged on the nacelle 104. During operation, the rotor 106 is caused to carry out a rotational movement by the wind and thereby drives a generator in the nacelle 104.

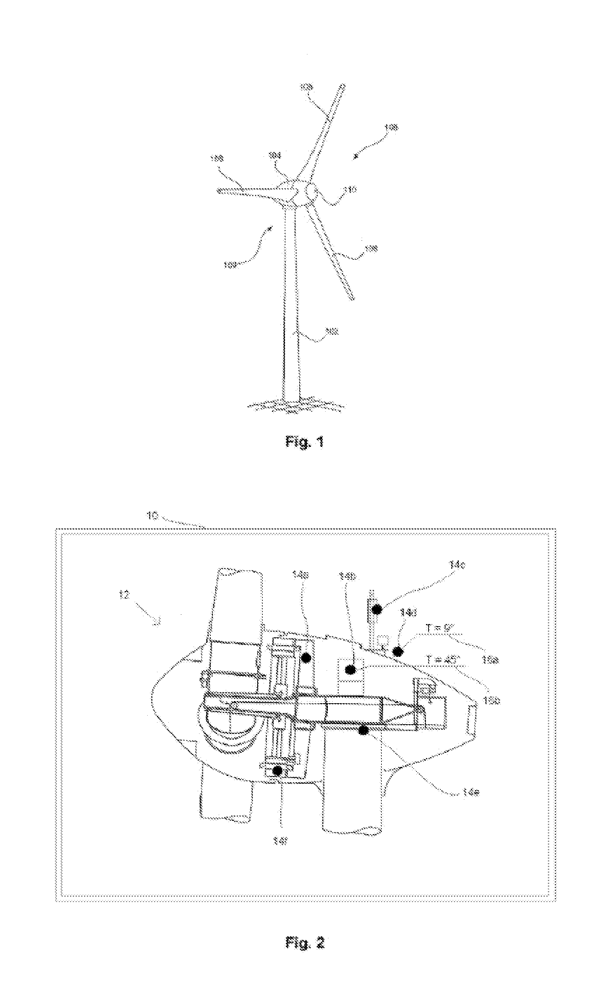

FIG. 2 shows a display 10 having a view 12 of a wind power installation 100. In addition to the view 12 of the wind power installation, a plurality of interaction elements 14a-14f are presented. The interaction elements 14a-14f have positions inside the view 12 of the wind power installation which correspond to positions at which sensors are likewise arranged in a real wind power installation 100.

The interaction element 14c is here assigned, for example, to a sensor which is arranged on an anemometer in the real wind power installation 100 and determines the wind speed. In the present case, the measured value, namely the wind speed, from this sensor is now represented by the interaction element 14c.

Furthermore, the interaction element 14d is assigned to a temperature sensor which is arranged above the nacelle 104 of a real wind power installation 100 behind an aircraft beacon of the wind power installation. As a result of the interaction element 14d being selected, it changes its appearance and is supplemented with labeling 16a, as is already illustrated here. The selection is carried out manually by a user using an input device, the selection being detected by a controller and the latter then displaying the labeling 16a on the display. The labeling 16a here contains the lettering “T=” and the current measured value “9°” stated after it.

A current measured value from a sensor corresponds to that measured value from a sensor which has been received last from the sensor or an interposed data processing unit by the controller which controls the display and assigns the measured values and interaction elements to one another.

In the exemplary embodiment of FIG. 2, yet another interaction element 14b is selected using an input device, with the result that labeling 16b is also displayed here.

The interaction element 14a is likewise assigned to a temperature sensor of the real wind power installation 100 and has a coloration which is not illustrated here and is dependent on the measured temperature from the assigned sensor. Here, the interaction element 14a has, for example, a green shade which indicates that the temperature from the sensor assigned to the interaction element 14a is in a standard range or a normal range. If the temperature measured with the sensor assigned to the interaction element 14a were to reach a critical value, the interaction element 14a would change color to red.

The different shades are presented using the controller which stores the different temperature ranges, such as normal range and/or critical range, for one or more sensors in a memory, the controller comparing the current measured values with these ranges and presenting the assigned interaction elements in the shade corresponding to the range according to the comparison result.

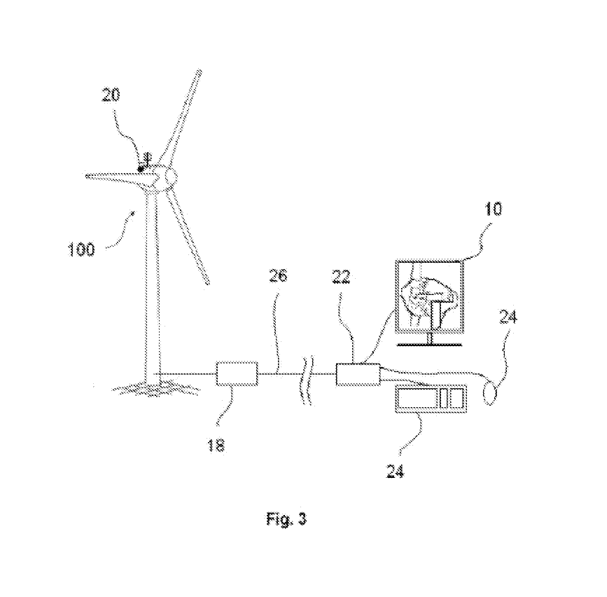

FIG. 3 shows a wind power installation 100 having a data processing device 18. The data processing device 18 is connected here to one sensor 20, by way of example. This illustration is exemplary since each of the sensors 20 of the wind power installation 100 is actually connected to the data processing device 18. The data processing device receives the sensor data and converts them into measured values. However, according to another embodiment, it is also possible for some sensors or a plurality of sensors 20 to each have their own electrical circuit which converts the sensor data, that is to say the raw data provided by the sensor 20, into measured values and supplies the converted measured values to the data processing device 18.

A controller 22 is now supplied with all measured values by the data processing device 18 and a display 10 is controlled using the controller 22. An input device 24 is also connected to the controller 22. The input device 24 is used to select one or more interaction elements 14a-14f which are presented using the display 10. The controller 22 also controls the display 10 and therefore presents an image of a wind power installation, which is stored in the controller 22, for example in a memory, on the display 10 in at least one view 12 of the image.

As already stated above, the measured values are supplied to the controller 22 by the data processing device 18. For this purpose, an exemplary connection 26 is illustrated between the data processing device 18 and the controller 22. Various connections 26 which are suitable for transmitting data are conceivable, in which case the controller 22 cannot be directly connected to the data processing device 18 for this purpose, but rather indirectly via one or more interposed electronic circuits.

According to one embodiment, the controller 22 is therefore, for example, part of a control room to which a multiplicity of wind power installations or wind farms are connected via one or more connections 26. For this purpose, the controller 22 which accordingly also receives the measured values from the sensors 20 of the multiplicity of wind power installations 100 or wind farms can initially be used to select a wind power installation whose current measured values can then be accessed via the display 10 using the interaction elements 14a-14f.

One of the interaction elements 14a-14f is now assigned to each sensor and its measured value using the controller 22, which interaction elements are then likewise presented by the controller 22 using the display 10. An input device 24 which is likewise connected to the controller 22 can then be used to select the interaction elements 14a-14f, a selection naturally being made electronically in the controller 22 and being presented for a user on the display 10 for comprehensibility.

The input device 24 can be used to select individual regions on the display 10, this selection being detected by the controller 22 and an enlarged presentation of this region which has been selected then being presented on the display 10 by means of the controller 22.

Measured values or measured value ranges of a plurality of sensors 20 of at least one wind power installation 100 are presented. The presentation makes it possible for a service employee to easily and quickly check the operating state of a wind power installation 100.

1. A method for presenting measurement data from a plurality of sensors of a wind power installation or components of the wind power installation using a display, the method comprising:
displaying, using the display, at least one view of an image of at least one wind power installation or of at least one component of the at least one wind power installation,
displaying a plurality of interaction elements together with the at least one view using the display,
assigning at least one sensor of at least one physical wind power installation or of at least one component of the at least one physical wind power installation to a respective interaction element of a plurality of interaction elements,
enabling retrieval or visualization of a measured value of the at least one sensor via the respective interaction element, and
arranging the assigned interaction element at a position in the at least one view displayed using the display which substantially corresponds to a position at which the at least one sensor assigned to the respective interaction element is arranged in the physical wind power installation or the at least one component of the at least one physical wind power installation.

2. The method as claimed in claim 1, comprising:
displaying the interaction element of the plurality of interaction elements at least partially in a respective color or shade, and
determining the color or shade of the interaction element based on a respective current measured value made by the at least one sensor assigned to the interaction element.

3. The method as claimed in claim 2, comprising:
displaying a first color or first shade if the current measured value made by the at least one sensor assigned to the interaction element is in a normal range that is predefined for the at least one sensor,
displaying a second color or second shade or a flashing second color or second shade if the current measured value made by the at least one sensor assigned to the interaction element is in a critical range that is predefined for the at least one sensor, and
displaying a third color or third shade if the current measured value made by the at least one sensor assigned to the interaction element is in a range between the normal range and the critical range.

4. The method as claimed in claim 2, comprising:
determining that the current measured value made by the at least one sensor is in a critical range or outside a designated normal range for the at least one sensor, and
in response to determining that the current measured value made by the at least one sensor is in the critical range or outside the designated normal range for the at least one sensor, enlarging or optically highlighting the interaction element assigned to the at least one sensor using the display.

5. The method as claimed in claim 1 comprising:
receiving, from an input device, a selection of the interaction element, and
displaying, using the display, a label on the interaction element indicating a current absolute or relative measured value of the at least one sensor assigned to the interaction element.

6. The method as claimed in claim 1, comprising:
storing, by the controller, the image of the at least one wind power installation or the component of the at least one wind power installation in a three-dimensional form having a plurality of views,
receiving, from an input device, a selection of the at least one view from the plurality of views, and
in response to receiving selection of the at least one view from the plurality of views, displaying the at least one view of the image of the at least one wind power installation or of the at least one component of the at least one wind power installation, wherein the image of the at least one wind power installation or the at least one component of the at least one wind power installation includes a plurality of two-dimensional views which are stored by the controller and displayed at the same time using the display.

7. The method as claimed in claim 1, comprising:
receiving, from an input device, a selection of a region of the at least one view, and
in response to receiving the selection of the region, enlarging the region when displaying the at least one view.

8. An apparatus for presenting measurement data from a plurality of sensors of a wind power installation or a component of the wind power installation, comprising:
a display configured to display a view of an image of at least one wind power installation or at least one component of the at least one wind power installation and display a plurality of interaction elements together with the view of the at least one wind power installation or the component of the at least one wind power installation, and
a controller configured to assign each interaction element of the plurality of interaction elements to a corresponding at least one sensor of the plurality of sensors of the wind power installation or the component of the wind power installation and enable retrieval or visualization of measured values of the at least one sensor using the assigned interaction element,
the controller being configured to cause each interaction element to be displayed on the display at a position in the view that substantially corresponds to a position at which the corresponding at least one sensor assigned to the interaction element is arranged in the wind power installation or the component of the wind power installation.

9. The apparatus as claimed in claim 8, wherein the controller is configured to determine a shade or color of the interaction element based on a current measured value made by the at least one sensor to which the respective interaction element is assigned and cause the interaction element to be displayed on the display in the color or shade.

10. The apparatus as claimed in claim 9, wherein the controller is configured to:
cause the interaction element to be displayed in a first shade or color when the current measured value made by the at least one sensor is in a normal range that is predefined for the at least one sensor,
cause the interaction element to be displayed in a second shade or color or cause the interaction element to be flashing when the current measured value made by the at least one sensor is in a critical range that is predefined for the at least one sensor, and
cause the interaction element to be displayed in a third shade or color when the current measured value made by the at least one sensor is in a range between the normal range and the critical range.

11. The apparatus as claimed in claim 8, wherein the controller is configured to:
determine that a measured value of at least one sensor to which the interaction element is assigned is in a critical range or a range outside a normal range for the at least one sensor, and
cause at least one of:
a region of the view in which the interaction element assigned to the at least one sensor is arranged to be optically highlighted, or
cause the region to be enlarged by the display.

12. The apparatus as claimed in claim 8, comprising: an input device configured to receive a selection of the interaction element, and wherein the controller is operatively coupled to the input device and configured to cause a current absolute or relative measured value made by the at least one sensor assigned to the selected interaction element as a label using the display.

13. The apparatus as claimed in claim 8, wherein the controller is configured to:
cause the image of the at least one wind power installation or the component of the at least one wind power installation to be stored in a three-dimensional form having a plurality of views, and
in response to receiving, from an input device, a selection of at least one view of the plurality of views, cause the selected at least one view to be displayed using the display.

14. The apparatus as claimed in claim 13, wherein the controller is configured to cause a region of the selected at least one view to be enlarged and displayed on the display.

15. A system, comprising:
an apparatus as claimed in claim 8,
the wind power installation, and
the plurality of sensors.

16. The method as claimed in claim 3, wherein the first color is green, the second color is red, and the third color is yellow.

17. The apparatus as claimed in claim 10, wherein the first color is green, the second color is red, and the third color is yellow.

18. The apparatus as claimed in claim 8, wherein the controller is configured to:
cause the image of the at least one wind power installation or the component of the at least one wind power installation to be stored as a plurality of two-dimensional views, and
cause the plurality of two-dimensional views to be displayed at the same time on the display.
